(19) United States
(12) Patent Application Publication
(10) Pub. No.: US 2024/0220717 A1
(43) Pub. Date: Jul. 4, 2024

(54) ADDING THEME-BASED CONTENT TO MESSAGES USING ARTIFICIAL INTELLIGENCE

(71) Applicant: Twilio Inc., San Francisco, CA (US)

(72) Inventor: Sachin Narayan Nagargoje, Bangalore (IN)

(21) Appl. No.: 18/090,482

(22) Filed: Dec. 28, 2022

(51) Int. Cl. G06F 40/186; G06F 3/0482; G06F 3/0484; G06F 40/106; G06F 40/174; H04L 51/10

(52) U.S. Cl. CPC G06F 40/186; G06F 3/0482; G06F 3/0484; G06F 40/106; G06F 40/174; H04L 51/10; G06F 40/143

(57) ABSTRACT

A message composition of a user is received by a communication platform. A theme identifier associated with a theme of the message composition is determined by the communication platform using a first machine learning model. A generated content item corresponding to the theme identifier is obtained by the communication platform using a second machine learning model. The generated content item is added to the message composition by the communication platform to produce a customized message to be transmitted to a plurality of recipient devices each associated with one of a plurality of recipients.

### TECHNICAL FIELD

Aspects and embodiments of the disclosure relate to electronic communications and content generation, and more specifically, to systems and methods for generating content (e.g., multimedia content) for inclusion in messages.

### BACKGROUND

Electronic communication technologies such as email and messaging applications enable users to draft messages and distribute them to other parties over the Internet or other communication channels. Messages are often provided as compositions featuring a variety of multimedia content, such as text, markup (e.g., HTML), images, animations, videos, and attachments. Users can prepare compositions in a graphical user interface (GUI), such as an email composition window. GUIs can further be used to permit users to select and include additional content (e.g., multimedia content) in the composition. Similar functions may be performed via an application programming interface (API).

Some systems can enable mass distribution of messages, such as transactional and communication messaging platforms. A user (e.g., an entity conducting a marketing campaign) typically drafts a single template composition (via e.g., a GUI or API), and the messaging platform handles distribution to a pre-defined or dynamic list of recipients (e.g., customers or potential customers) as part of a marketing campaign. Generally, an automated messaging system or platform allows a marketer to establish various messaging campaigns, where each individual messaging campaign may involve a series of messages (e.g., email, SMS or text messages) that are automatically communicated to a contact that is specified as a targeted message recipient for the messaging campaign. For a specific messaging campaign, a marketer can generally create a series or sequence of messages that are to be communicated to a recipient, one message at a time and in an order established by the marketer. Messaging platforms may further customize the template composition for individual recipients by, e.g., filling in the recipient's name in the message body.

### BRIEF DESCRIPTION OF THE DRAWINGS

Aspects and embodiments of the disclosure will be understood more fully from the detailed description given below and from the accompanying drawings of various aspects and embodiments of the disclosure, which, however, should not be taken to limit the disclosure to the specific aspects or embodiments, but are for explanation and understanding.

FIG. 1 is a block diagram illustrating an example system architecture for an electronic communication platform, according to at least one embodiment.

FIG. 2 illustrates an example message composition pipeline graphical user interface for a messaging system of a transactional and communication messaging platform, according to at least one embodiment.

FIG. 3A illustrates an example template field for multimedia content, according to at least one embodiment.

FIG. 3B illustrates an example segmented template field for multimedia content, according to at least one embodiment.

FIG. 3C illustrates an example segmentation management graphical user interface view, according to at least one embodiment.

FIG. 4A is a flow diagram of a method for theme-based multimedia attachment to message compositions using artificial intelligence, according to at least one embodiment.

FIG. 4B is a flow diagram of a method for determining a theme identifier associated with a theme of a message composition, according to at least one embodiment.

FIG. 4C is a flow diagram of a method for obtaining a generated multimedia content item corresponding to a theme identifier, according to at least one embodiment.

FIG. 4D is a flow diagram of a method for adding a generated multimedia content item to a message composition, according to at least one embodiment.

FIG. 5 illustrates an example machine learning training and inference pipeline for a theme determination tool, according to at least one embodiment.

FIG. 6 illustrates an example machine learning training and inference pipeline for a multimedia content item generation tool, according to at least one embodiment.

FIG. 7 is a block diagram illustrating an exemplary computer system, according to at least one embodiment.

### DETAILED DESCRIPTION

Electronic communication platforms, such as email and messaging platforms, can offer various tools, services, and integrations to assist user in drafting and sending messages. For example, an email platform may offer a browser-based graphical user interface (GUI) to facilitate composing and sending an email. The GUI may permit the user to customize the look and feel of the email by providing GUI elements to control font attributes (e.g., color, size, style), create lists and tables, insert signature blocks, and insert a variety of content (e.g., multimedia content such as images, animations, videos, and audio clips), for example. These customizations may be encoded and represented using a variety of methods, such as markup languages (e.g., HTML) and attachments (e.g., based on the MIME standard). Users may interact with email platforms using other channels to a similar effect, such as via an application programming interface (API) or a third-party email client (e.g., Mozilla Thunderbird®). These and other features may be available for other messaging platforms and protocols as well, such as text messaging or mobile messaging platforms, social media platforms, presentation and content creation platforms, etc.

Some electronic communication platforms provide features to facilitate mass distribution of messages to a plurality of recipients (e.g., as part of an automated messaging campaign). Transactional and communication messaging platforms, for example, enable a user (e.g., an entity conducting a marketing campaign) to compose a template message that should be sent to a distribution list of recipients (e.g., customers or potential customers). Platforms may support pre-defined lists of recipients, dynamically generated lists of recipients, or a combination of both. Platforms may further support simultaneous delivery, delivery over a period of time, or delivery in response to various triggers. Messaging platforms may further customize the template message composition for individual recipients by, e.g., filling in the recipient's name in the message body. Twilio SendGrid® is an example of a transactional and communication messaging platform. In the context of a transactional and communication messaging platform, the terms “user,” “entity,” and “marketer” are used synonymously in reference to a person or organization who uses a software-based messaging platform or system to establish and conduct an automated messaging campaign. Similarly, the terms “recipient” and “customer” are used synonymously in reference to a person (or group of people) who is specified as part of a target audience for an automated messaging campaign, and as a result, receives messages as part of an automated messaging campaign.

Users often wish to add additional content (e.g., multimedia content) to their message compositions when drafting a message. Continuing the email example above, a user may desire to add an image to their draft email to complement the content of the body of the email. Some messaging platforms or third-party services may provide stock images for the user to choose from, or the user may search the Internet for images or use their own images. For example, a user may be drafting a “Happy New Year” email to friends and family and may wish to include a relevant New Year's image in the email body. The user may proceed to search the Internet or a stock image service for images and may use a variety of queries from broad (e.g., “New Year's images”) to narrow (e.g., “New Year's celebration in the United States with fireworks and beverages”) based on their precise desires. However, users may experience difficulty in finding appropriate content for their message compositions due to a variety of factors. Some users may struggle to appropriately summarize the themes or concepts of their message composition in order to generate effective search queries. For example, “New Year's images” may be too broad in some cases and the search engine may not yield any images that the user likes. Likewise, a user's content preferences may be so narrow and specific that no relevant images exist. If a user utilizes a search engine to search the Internet for content, they may risk running afoul of copyright and other intellectual property laws in their jurisdiction by unwittingly appropriating content that they don't have rights or license to. On the other hand, a user relying on a stock multimedia service, such as a stock image library, may find that the selection of stock content is too limited. Stock image libraries may also be prohibitively expensive for some users.

Users of mass distribution platforms such as transactional and communication messaging platforms may face other challenges in addition to those mentioned above. In some use cases, a user (e.g., an entity conducting a marketing campaign) may wish to include different content items for different recipients or recipient segments (e.g., classes or groups of recipients). Recipients may be segmented by location, gender, age, employer, or other affiliation, for example. In the New Year's email example, the user's distribution list may include customers in the United States and India, and the user may wish to attach culturally relevant New Year's images to the email based on the recipient's location. In another example, a user's distribution list may include recipients employed at three different companies, and the user may desire that each recipient receive an image with colors matching their company's logo. In another example, a user may be running a messaging campaign and may wish to conduct A/B testing with two or more images to determine which images are associated with a higher click-through rate. In these and other situations, the user may find it prohibitively time consuming to search for and gather multiple images for multiple recipients or recipient segments. These queries are naturally narrower and may yield no relevant results in some situations. Furthermore, some mass distribution platforms may not easily support including content targeted at a subset of recipients. The intellectual property challenges previously mentioned are of heightened concern in the context of mass distribution platforms, and stock multimedia services with mass distribution rights may be substantially more expensive.

Aspects and embodiments of the present disclosure address the above-mentioned and other challenges by providing systems and methods to assist users in determining thematic elements of their message compositions and generating relevant content (e.g., multimedia content) in an integrated workflow. Aspects and embodiments of the present disclosure may employ artificial intelligence and machine learning algorithms for one or more components of the workflow. Aspects and embodiments of the present disclosure may utilize graphical user interfaces (GUIs), application programming interfaces (APIs), or other interfaces to interact with users, recipients, and other parties.

Aspects and embodiments of the present disclosure may provide theme determination tools and services to determine thematic elements of a message composition. Thematic elements may be represented by theme identifiers, which may be textual captions, summaries, or descriptions of the message composition. Theme identifiers may also be other data structures, such as a set of keywords or a dictionary of keywords with associated relevance weights. Theme identifiers may be associated with additional metadata, such as data indicating the relevance or ranking of a theme identifier. Once a message composition has been received, a theme determination tool may determine one or more theme identifiers associated with one or more themes of the message composition by using automated procedures, user interaction, or a combination of the above. Aspects and embodiments of the present disclosure may initially generate one or more theme candidates associated with a theme or themes of the message composition. In at least one embodiment, the theme candidates are provided for presentation to a user and user input is received indicating the theme identifier(s). The user input may be a selection indicating one or more theme candidates, such as a mouse click or an index indicating the position of the selected theme(s) within the presented themes. The user input may be a full or partial copy of one of the presented theme(s) selected by the user. Similarly, the user input may be a modified copy of a presented theme (e.g., edited by the user), or a user-generated theme that may not be present among the presented themes.

In at least one embodiment, theme candidate generation involves providing content of the message composition as input to a machine learning model and obtaining the theme candidates as output from the machine learning model. The machine learning model may utilize one or more of a variety of model architectures and mechanisms, such as recurrent neural networks (RNNs), convolutional neural networks (CNNs), multi-layer perceptron neural networks (MLPs), transformers (e.g., encoder-decoders), diffusion models, self-attention, deep versions of these architectures, or combinations of these architectures, for example. The machine learning model may be trained with a variety of learning methods such as supervised learning, unsupervised learning, semi-supervised learning, reinforcement learning, generative techniques, adversarial techniques, transfer learning techniques, or other methods and techniques. In at least one embodiment, training data may comprise pairs of text (e.g., features) and thematic identifiers (e.g., labels). Training data may be hand-curated, automatically curated (e.g., by web scraping), generated by other machine learning models, or similar. In at least one embodiment, training data is augmented with additional data gathered from users of the platform, such as by recording selected and modified theme identifiers. Data may be further tuned by, e.g., adding weights representing user preferences or rankings of theme identifier quality. In at least one embodiment, training data may include additional features relevant to a messaging context, such as email/message subject, reply or messaging history, recipient-specific data (e.g., location, gender, age, employer), or similar. In at least one embodiment, a pre-trained transformer (or other architecture) such as GPT-3® is used as a starting point, and transfer learning techniques are used in combination with the above-mentioned features and labels to produce a tailored machine learning model for generating theme candidates.

Aspects and embodiments of the present disclosure may provide content generation tools and services to obtain or generate content items related to the theme identifier(s). Content items may include multimedia content items such as images, graphics, animations (e.g., GIFs), videos, audio, or a combination of these or other content. Content items may also encompass graphical theme overlays for the message composition, such as font style and color, border shapes and colors, background graphics, signature blocks, and similar. Multimedia content items are used as examples herein, but content items may be non-multimedia as well. Content items may be associated with additional metadata, such as data indicating the relevance or ranking of a content item with respect to the theme identifier(s). Once one or more identifiers have been indicated, a content generation tool may obtain one or more content items to add to the message composition by using automated procedures, user interaction, or a combination of these. Aspects and embodiments of the present disclosure may initially generate or retrieve (e.g., retrieve from a stock image library) one or more content item candidates associated with the theme identifier(s). In at least one embodiment, the content item candidates are provided for presentation to a user and user input is received indicating the content items to add to the message composition. The user input may be a selection indicating one or more content items, such as a mouse click or an index indicating the position of the selected content items within the presented content items. The user input may be a full or partial copy of the presented content item(s) selected by the user. Similarly, the user input may be a modified copy of a presented content item (e.g., edited by the user in an image editor), or a user-generated content item that may not be present among the presented themes (e.g., an uploaded image).

In at least one embodiment, content generation involves providing the theme identifier(s) as input to a machine learning model and obtaining the content item candidates as output from the machine learning model. The machine learning model may utilize one or more of a variety of model architectures and mechanisms, such as recurrent neural networks (RNNs), convolutional neural networks (CNNs), multi-layer perceptron neural networks (MLPs), transformers (e.g., encoder-decoders), diffusion models, self-attention, deep versions of these architectures, or combinations of these architectures, for example. The machine learning model may be trained with a variety of learning methods such as supervised learning, unsupervised learning, semi-supervised learning, reinforcement learning, generative techniques, adversarial techniques, transfer learning techniques, or other methods and techniques. In at least one embodiment, training data may comprise pairs of theme identifiers (e.g., features) and images or other content items (e.g., labels). Training data may be hand-curated, automatically curated (e.g., by web scraping), generated by other machine learning models, or similar. In at least one embodiment, training data is augmented with additional data gathered from users of the platform, such as by recording selected and modified content items. Data may be further tuned by, e.g., adding weights representing user preferences or rankings of generated content quality. In at least one embodiment, training data may include additional features relevant to a messaging context, such as email/message subject, reply or messaging history, recipient-specific data (e.g., location, gender, age, employer), or similar. In at least one embodiment, a pre-trained diffusion model (or other architecture) such as DALL-E® is used as a starting point, and transfer learning techniques are used in combination with the above-mentioned features and labels to produce a tailored machine learning model for generating content item candidates.

Aspects and embodiments of the present disclosure may provide an iterative process of refining theme identifiers and generated content items to facilitate more precise control over the generated content. For example, after presenting the content item candidates to the user, the user may determine that none of the content item candidates are satisfactory. The user may update the theme identifier(s) (e.g., by changing or editing the previous selection) and submit the updates to the content generation tool. In at least one embodiment, the content generation tool proceeds as before, generating updated content item candidates based solely on the updated theme identifier inputs and presenting them to the user. In at least one embodiment, the content generation tool considers the updated theme identifier inputs, as well as the originally selected theme identifier(s) and/or the previously generated content items. A machine learning model trained on current and previous theme identifiers and previous content item candidates may, in some situations, provide more continuity between previous and updated content item candidates and better represent minor changes in the theme identifier(s). The iterative process may continue until the user has indicated a satisfactory content item or items, which may then be added to the message composition.

Aspects and embodiments of the present disclosure may enable automatic placement of content items in the message composition. In at least one embodiment, template fields may be added to the message composition to indicate where content items should be placed. Once one or more content items have been indicated, the template fields may be automatically replaced with the indicated content item(s). In at least one embodiment, a template field may further indicate that different content items should be added to the message composition for different recipients. Recipients may be divided by recipient segments, such as by location, gender, age, employer, or similar. In at least one embodiment, the content generation machine learning model is trained with training data including recipient segments as an additional feature or features. The content generation machine learning model may then generate different images for different recipient segments based on the same theme, and the images may then be inserted in the message composition for each recipient or recipient segment.

Accordingly, aspects and embodiments of the present disclosure determine thematic elements of user message compositions and generate relevant content for the message compositions for individual recipients or individual recipient segments. As a result, users no longer need to perform iterative searches to find appropriate content for their message compositions and to gather numerous content items for multiple recipients or recipient segments, which can improve overall system workflow and reduce the amount of time users spend interacting with the electronic communication platform. Accordingly, fewer computing resources are consumed by the electronic communication platform, which improves an overall efficiency of a system including the electronic communication platform and decreases overall latency of the system. Aspects and embodiments of the present disclosure also provide the user with more control over generated content, which can improve user retention and user satisfaction with the platform. Furthermore, aspects and embodiments of the present disclosure address the intellectual property challenges that could be otherwise faced by users of a mass distribution platform, thereby improving the overall experience of the users of the mass distribution platform and increasing their trust in the services provided by the mass distribution platform.

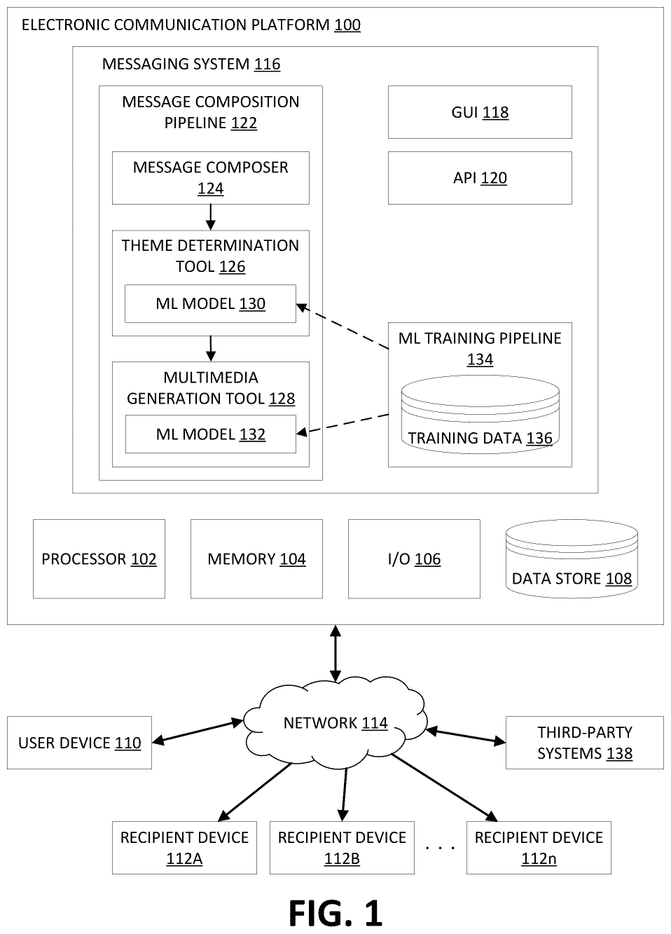

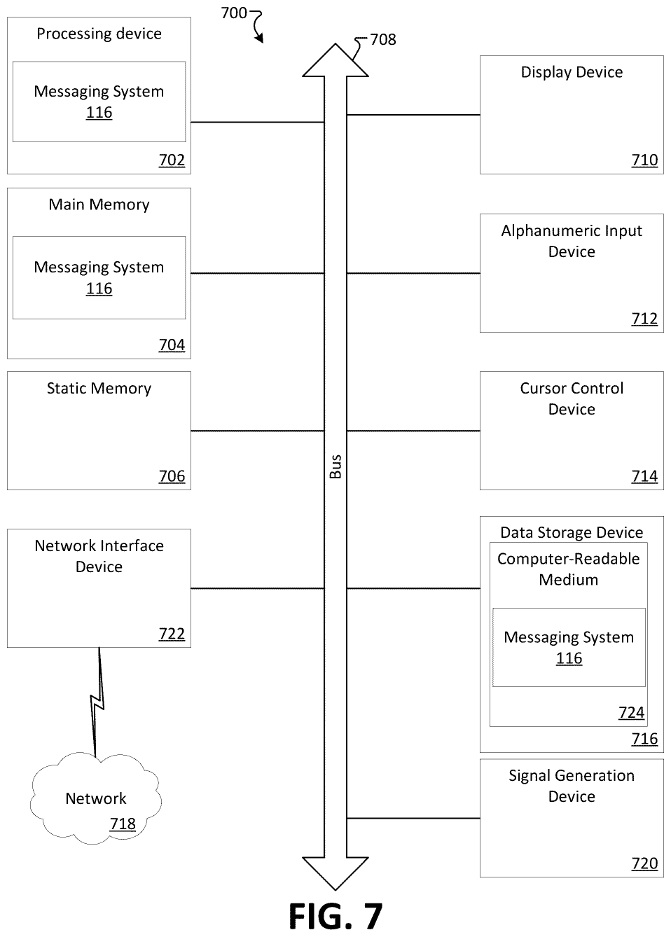

FIG. 1 illustrates an example system architecture for an electronic communication platform 100, in accordance with at least one embodiment. In at least one embodiment, electronic communication platform 100 is a computer system and may comprise processor(s) 102, a memory 104, input/output peripherals 106, data store(s) 108, and other components. These components may be discrete components that comprise electronic communication platform 100, they may be part of a monolithic system such as a system-on-chip, or they may be virtual components virtualized by, e.g., a hypervisor. An example computer system is described in further detail with respect to FIG. 7. In at least one embodiment, electronic communication platform 100 corresponds to one or more of a data center, a server, a personal computer, a smartphone, a tablet, a virtual machine, a containerized application, or similar.

In at least one embodiment, electronic communication platform 100 is connected to a user device 110 of a user and one or more recipient devices 112A-n of one or more recipients through a network 114. Network 114 may be a local area network (LAN), a wide area network (WAN), a cellular network, the Internet, a virtual private network (VPN), or similar. In at least one embodiment, network 114 may be a hardware bus or communication protocol, such as PCIe, USB, SPI, I2C, UART, or similar. In at least one embodiment, network 114 is absent and user device 110 and recipient devices 112A-n connect directly to electronic communication platform 100. In at least one embodiment, a user associated with user device 110 is a subscriber of electronic communication platform 100 (e.g., paid, free, trial, or complementary subscriber), and may have an email address(s), phone number(s), or other credentials associated with their subscription. A user associated with user device 110 may be an individual or organizational subscriber, such as a marketer or an entity conducting a marketing campaign, for example. In at least one embodiment, electronic communication platform 100 may store configuration data (e.g., in data store(s) 108) associated with an account of a user or subscriber. Configuration data may relate to all messages and messaging campaigns in the user's account or may be unique to one or more messages and messaging campaigns. Configuration data may include the messages or message templates and rules dictating which recipients receive which messages, the order in which to send the messages, communication protocols to be used to send the messages, the duration of time between sending messages, other triggers for sending messages, and similar. In at least one embodiment, recipient devices 112A-n are capable of receiving messages dispatched from electronic communication platform 100. Recipients associated with recipient devices 112A-n may be individuals or organizations, subscribers or non-subscribers, etc. For example, a recipient may be an individual with an email account hosted and managed by a third-party email provider, and the third-party provider receives messages on the recipient's behalf.

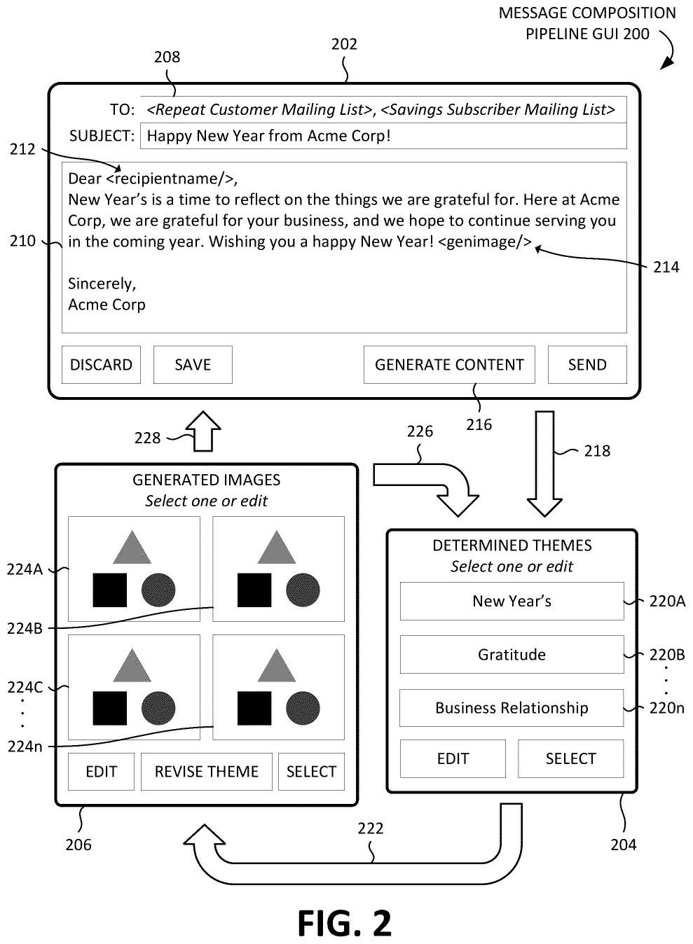

In at least one embodiment, electronic communication platform 100 contains one or more applications, such as messaging system 116. Messaging system 116 may be implemented as software (e.g., running on processor(s) 102), as hardware, or as a combination of software and hardware in at least one embodiment. Messaging system 116 may utilize resources of electronic communication platform 100 (e.g., I/O 106) to interact with user device 110 (e.g., via network 114) and provide messaging services such as email and text messaging. Messaging services may include functionality for sending messages to one or more recipients, such as one or more recipients associated with recipient devices 112A-n. In at least one embodiment, messaging system 116 interacts with a user associated with user device 110 via graphical user interface 118. For example, GUI 118 may be a browser-based email client, a desktop email client, or a mobile messaging application. An example GUI is further described with respect to FIG. 2 herein. In at least one embodiment, messaging system 116 interacts with user device 110 via application programming interface 120. For example, API 120 may be a REST API, a software library or SDK, or similar. API 120 may provide the same or similar functionality as the example GUIs described herein, or API 120 may provide more, less, or different functionality. In at least one embodiment, electronic communication platform 100 may provide only GUI 118, only API 120, or both GUI 118 and API 120 for user interaction. In at least one embodiment, messaging system 116 includes features to facilitate mass distribution of messages to a plurality of recipients, such as recipients associated with recipient devices 112A-n. For example, messaging system 116 may manage message templates, distribution lists, and bulk or timed message dispatch. Other and similar features are further described herein.

In at least one embodiment, messaging system 116 provides a message composition service that performs a set of message composition operations referred to herein as message composition pipeline 122. A user associated with user device 110 may use message composition pipeline 122 to compose messages such as emails and text messages and attach relevant multimedia content such as images, animations, videos, and audio. Message composition pipeline 122 may include a message composer such as message composer 124, which may be used by a user associated with user device 110 to draft the contents of a message (e.g., email subject and body). Message composition pipeline 122 may further include a theme determination tool such as theme determination tool 126 to analyze the contents of the message and generate theme identifiers such as captions, descriptive summaries, or similar. Message composition pipeline 122 may further include a multimedia content generation tool such as multimedia generation tool 128 to generate multimedia content items for inclusion in the message composition. Multimedia generation tool 128 may utilize the theme identifiers generated by theme determination tool 126 to generate multimedia content items. In at least one embodiment one or both of theme determination tool 126 and multimedia generation tool 128 may include a machine learning model to perform some of their functions, such as machine learning models 130 and 132. Message composition pipeline 122 may include other components in addition to those identified in FIG. 1. In at least one embodiment, message composition pipeline 122 may include a subset of the components identified in FIG. 1. An example message composition pipeline is further described with respect to FIG. 2 herein.

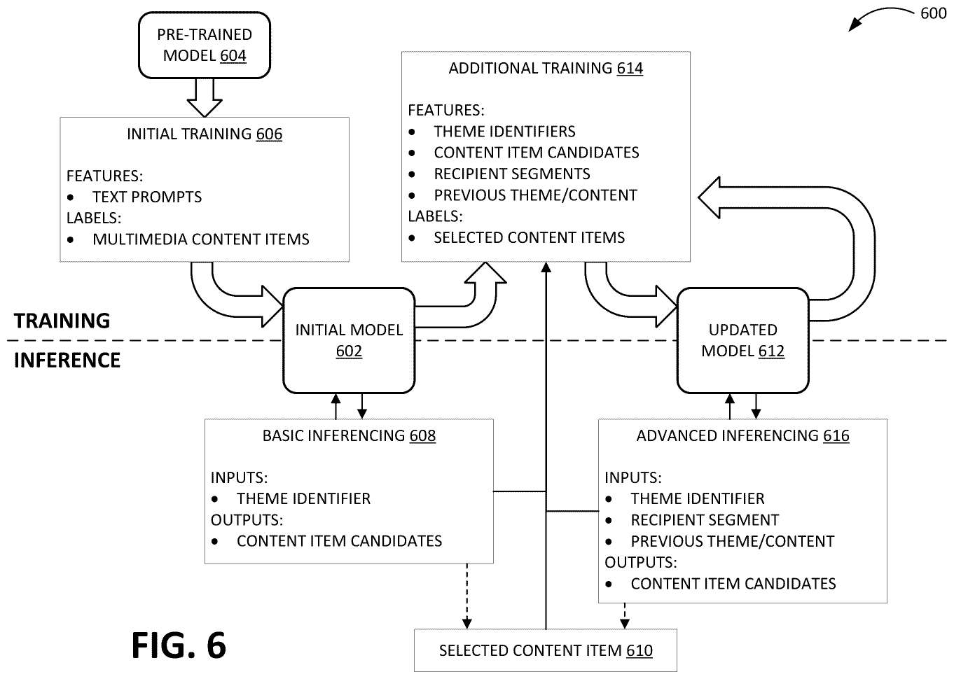

In at least one embodiment, messaging system 116 includes machine learning training pipeline 134. Machine learning training pipeline 134 may include tools and resources relevant to training machine learning models, such as frameworks for designing neural networks and performing backpropagation and gradient descent, a selection of pre-trained models, tools for curating and cleaning training data, and similar. Machine learning training pipeline 134 may be used to train machine learning models 130 and 132 associated with theme determination tool 126 and multimedia generation tool 128, respectively. Training may occur before deployment of electronic communication platform 100 in order to provide initial machine learning models 130 and 132. Training may also continue during operation of electronic communication platform 100 to provide updated machine learning models 130 and 132. Machine learning training pipeline 134 may use training data 136 for training. Training data 136 may be compiled from a variety of data sources external to electronic communication platform 100, such as third-party data sets or proprietary data sets gathered in-house. Training data 136 may also include data gathered during operation of electronic communication platform 100, such as user feedback related to theme determination tool 126 or multimedia generation tool 128. Such feedback may be used to further refine the models, for example. Example machine learning training pipelines are further described with respect to FIGS. 6 and 7 herein. In at least one embodiment, machine learning training pipeline 134 may be external to messaging system 116 and/or electronic communication platform 100, and may reside in dedicated hardware, cloud resources, or similar. Trained machine learning models 130 and 132 may be communicated from external machine learning platform 134 to messaging system 116 via I/O peripherals 106 and/or network 114.

In at least one embodiment, electronic communication platform 100 integrates (or is integrated with) one or more third-party systems, such as third-party systems 138. Third-party systems may include various services and content sources, such as stock image libraries, spelling and grammar checkers, advertising and analytics services, and similar. In at least one embodiment, one or more of these services or content sources may be integrated in electronic communication platform 100 as a first-party integration (e.g., in-house analytics platform).

FIG. 2 illustrates an example message composition pipeline graphical user interface 200 (which may correspond to GUI 118 and message composition pipeline 122 of FIG. 1) for a messaging system of a transactional and communication messaging platform, in accordance with at least one embodiment. Message composition pipeline GUI 200 includes composition view 202, theme selection view 204, and multimedia content item selection view 206. In at least one embodiment, message composition pipeline GUI 200 may include a subset of the views depicted in FIG. 2 or additional views not depicted. Views may correspond to various GUI components, such as windows, screens, pages, popups, document sections (e.g., HTML <div>), textual user interfaces, accessible interfaces (e.g., audio-based), and similar. A user (e.g., via user device 110) may interact with the views depicted in FIG. 2 using a mouse, keyboard, touchscreen, display, speaker, microphone, or other methods as appropriate. Message composition pipeline GUI 200 may be adapted for other platforms, such as consumer email platforms or mobile messaging applications.

Composition view 202 is an example message composer view. In at least one embodiment, composition view 202 may include a recipient field such as recipient field 208 for entering individual recipients or distribution lists. Composition view 202 may further include a message body editing area 210, where the user may enter text, add graphics and multimedia, format the look and feel of the document, and similar. Composition view 202 may include additional UI elements, such as buttons for sending, saving, or discarding the message composition.

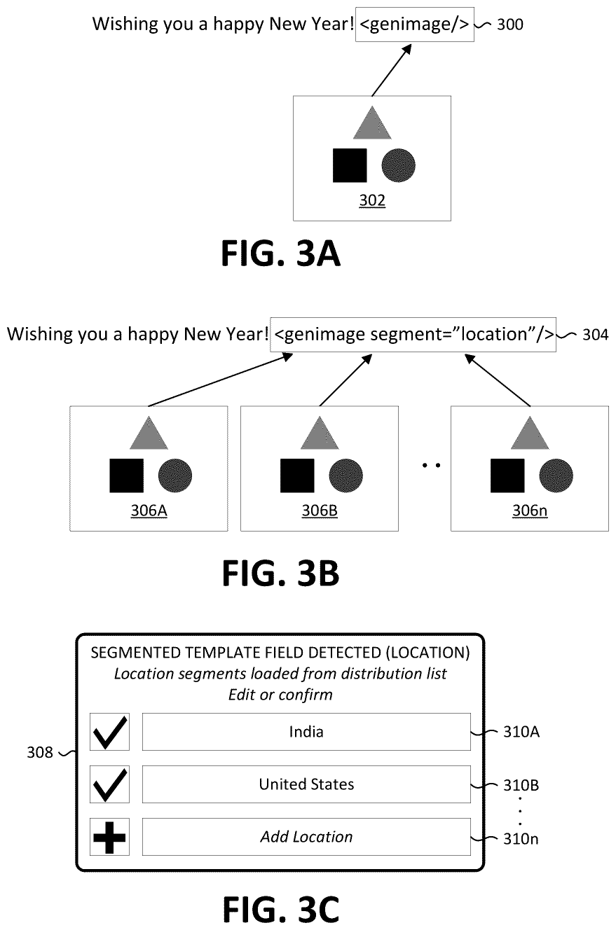

Composition view 202 may support template fields to assist in customizing the draft message composition based on various data. For example, recipient name template field 212 may indicate to the messaging system that the user wishes to place the recipient's name at this position for each recipient in the distribution list (e.g., in recipient field 208). Generated image template field 214 may indicate to the messaging system that the user wishes to place a generated image at this position in the document. Generated image template field 214 is further described with respect to FIG. 3 herein. Other template fields may be provided for other types of multimedia content items. As an additional example not depicted in FIG. 2, a greeting template field may replace the greeting text with “Good morning,” “Good afternoon,” or “Good evening,” based on the time of day the message is dispatched. In at least one embodiment, template fields may be inserted into the message composition body using a markup language, such HTML or XML tags. In at least one embodiment, composition view 202 may include UI elements to facilitate dragging and dropping template fields into the message composition body.

Composition view 202 may include a UI button such as generate content button 216 to instruct the messaging system to process one or more template fields and fill in their content (e.g., replace generated image template field 214 with a generated image). Generate content button 216 may also permit the user to generate content and manually insert it (e.g., drag and drop) without using template fields. In at least one embodiment, one or more template fields are processed automatically (e.g., on message dispatch) without requiring user interaction. Recipient name template field 212 may be an example of a template field that is processed automatically.

In at least one embodiment, theme selection view 204 is displayed in response to a content generation process being automatically or manually invoked (e.g., the user activating generate content button 216). At 218, prior to displaying theme selection view 204, the messaging system may determine one or more theme candidates 220A-n using the systems and methods described herein (e.g., ML model 130). Theme selection view 204 may display theme candidates 220A-n and permit the user to select one or more theme identifiers from theme candidates 220A-n. Theme selection view 204 may also permit the user to edit one or more of theme candidates 220A-n or manually input a completely new theme identifier if the user does not find one or more of the original theme candidates 220A-n satisfactory. In at least one embodiment, user selections and edits are recorded and stored as additional training data (e.g., in training data 136) for refining a theme determination machine learning model (e.g., ML model 130). In at least one embodiment, theme selection view 204 may not be displayed and the messaging system may automatically determine one or more theme identifiers (e.g., by selecting the theme candidate with the highest accuracy level determined by ML model 130).

In at least one embodiment, multimedia content item selection view 206 is displayed in response to one or more theme identifiers being automatically or manually selected. At 222, prior to displaying multimedia content item selection view 206, the messaging system may generate one or more multimedia content item candidates such as image candidates 224A-n using the systems and methods described herein (e.g., ML model 132). In at least one embodiment, multimedia content item candidates may also be selected from a collection of pre-existing multimedia content items (e.g., from third-party systems 138 such as a stock image library) or may be a combination of generated and pre-existing content items. Multimedia content item selection view 206 may display image candidates 224A-n and permit the user to select one or more images to include in the message composition. In at least one embodiment, multimedia content item selection view 206 may permit the user to edit one or more of image candidates 224A-n (e.g., in an image editor window not depicted) or manually load a new image (e.g., from a personal collection or stock image library) if the user does not find one or more of the original image candidates 224A-n satisfactory. In at least one embodiment, multimedia content item selection view 206 may not be displayed and the messaging system may automatically obtain or generate one or more multimedia content items (e.g., by selecting the multimedia content item candidate with the highest accuracy level determined by ML model 132).

In at least one embodiment, multimedia content item selection view 206 may permit the user to revise the theme identifier by returning to theme selection view 204 at 226 to edit theme identifiers as previously described. Thus, the user may initiate a plurality of cycles of revising theme identifiers and evaluating the generated images until they find images they like. This process may be advantageous for providing the user with more granular control over the generated images and a faster modification and evaluation cycle. In at least one embodiment, theme selection view 204 and multimedia content item selection view 206 may be displayed simultaneously to facilitate live updates to the generated images as the theme identifiers are being revised. In at least one embodiment, user selections and edits in multimedia content item selection view 206 are recorded and stored as additional training data (e.g., in training data 136) for refining a multimedia content generation machine learning model (e.g., ML model 132).

At 228, the messaging system may facilitate inserting the one or more selected multimedia content items (e.g., images) from multimedia content item selection view 206 into the message composition. In at least one embodiment, the application may automatically replace relevant template fields such as generated image template field 214 with the selected content item(s), as further described with respect to FIG. 3 herein. In at least one embodiment, the user may manually insert selected content items into the composition, e.g., by dragging and dropping.

FIGS. 3A-C illustrate example template fields and additional GUI elements related to template field segmentation, in accordance with at least one embodiment. In at least one embodiment, an unsegmented template field such as template field 300 of FIG. 3A may be included in the message composition. For example, template field 300 may correspond to generated image template field 214 of FIG. 2. As described herein, the messaging system may automatically replace template field 300 with a multimedia content item for all recipients, such as image 302. Continuing the New Year's email example, image 302 may be a generic New Year's celebration image. Replacement may occur at the end of the theme determination and multimedia content item generation sequence described with respect to FIG. 2. Replacement may also occur just before messages are dispatched to recipients, after receiving a prompt or command from a user, or at another time as appropriate. In at least one embodiment, a template field may not be part of the message body but may be associated with the message body in other ways. For example, a platform may enable users to provide a regular expression (regex) as part of an API or scripting interface to indicate to the application where to place the multimedia content item in the message body. The application may evaluate the regular expression and place the multimedia content item appropriately.

In at least one embodiment, a segmented template field such as template field 304 of FIG. 3B may include additional information indicating to the application that the template field should be replaced with different content for different segments of recipients. For example, template field 304 indicates that recipients should be segmented based on location, and different multimedia content items should be added to the message for each segment of recipients. The messaging system may automatically replace template field 304 with different multimedia content items for different recipient segments, such as images 306A-n. Continuing the New Year's email example, image 306A may depict a New Year's celebration in the United States for U.S.-based recipients, and image 306B may depict a New Year's celebration in India for India-based recipients. As described with respect to FIG. 3A and elsewhere herein, replacement may occur at various times, and template field 304 may take various forms (e.g., HTML, XML, markup, script, regex, GUI drag-and-drop elements).

The segments for a segmented template field such as template field 304 may be determined manually, automatically, or by a combination of manual and automatic methods. In at least one embodiment, the messaging system may analyze metadata associated recipient distribution lists or databases to determine the segments. For example, a distribution list may contain contact information for each recipient (or a link to contact information in a database) including residential address. The application may analyze the distribution list to determine that all recipients live in either India or the United States and segment the template field accordingly. In at least one embodiment, the messaging system may detect a segmented template field and prompt the user to provide the segments. The user may provide the segments by listing the segment names (e.g., “India” and “United States”) or providing a list of recipients in each segment, for example. In at least one embodiment, the messaging system may determine the segments randomly. For example, a user may be conducting a messaging campaign and may wish to A/B test two or more multimedia content items to see which is associated with a higher click-through rate. The user may direct the application to randomly segment the recipients and attach the multimedia content items along with a web beacon (e.g., tracking pixel) to provide data for the A/B test. Returning to the New Year's email example, the user may wish to A/B test an image with fireworks and an image with beverages to determine which has a higher click-through rate. In at least one embodiment, segmentation may be determined by a segmentation engine of the platform, which may also perform other segmentation activities related to transactional messaging and messaging campaigns.

FIG. 3C illustrates an example segmentation management GUI view 308, which may be displayed as part of message composition pipeline GUI 200 when segmented template fields are detected. Segmentation management GUI view 308 may be displayed before theme selection view 204 (e.g., at 218), with theme selection view 204, or after theme selection view 204 (e.g., at 222), for example. In at least one embodiment, segmentation management GUI view 308 may display segments that have been automatically detected, such as segments 310A-n, and request user confirmation before proceeding to replace a segmented template field with multimedia content items. In at least one embodiment, segmentation management GUI view 308 may permit the user to add, remove, or modify segments 310A-n before proceeding.

In at least one embodiment, segmentation data may be provided as input to a machine learning model (e.g., ML model 132) prior to generating multimedia content items (e.g., at 222). The machine learning model may then generate multimedia content item candidates for each segment based on the indicated theme identifier and the respective segment. One or more multimedia content item selection views 206 may be displayed to permit the user to select multimedia content items for each segment. In at least one embodiment, the user may select a representative multimedia content item for one segment (e.g., using multimedia content item selection view 206), and the messaging system may automatically select multimedia content items for the other segments based on the representative selection. In at least one embodiment, a user-selected representative multimedia content item may be provided as input to a machine learning model for an additional round of multimedia content item generation. The machine learning model may use the representative selection along with the segmentation data to generate similar multimedia content items customized for each segment.

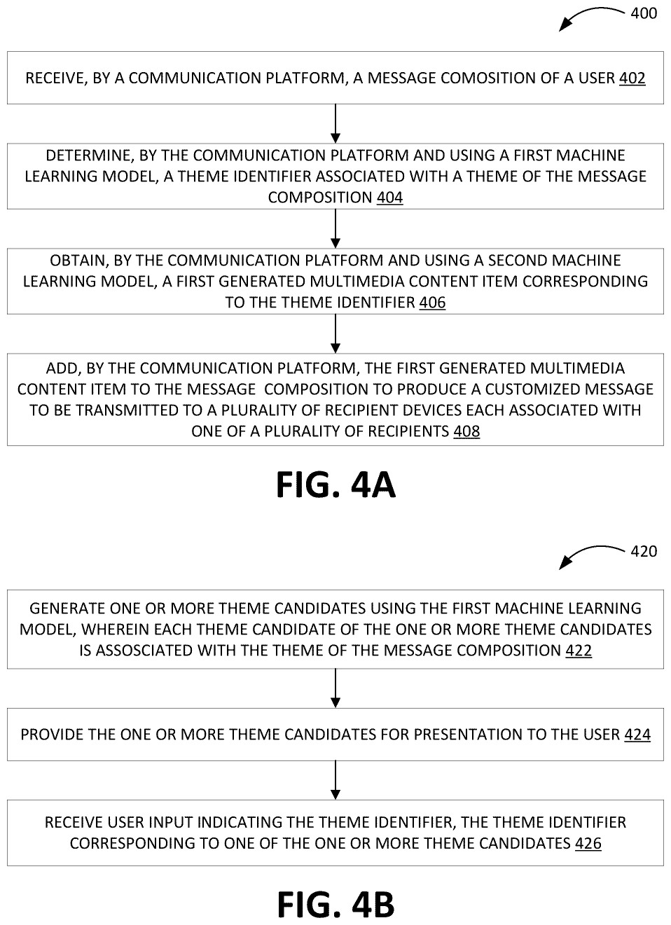

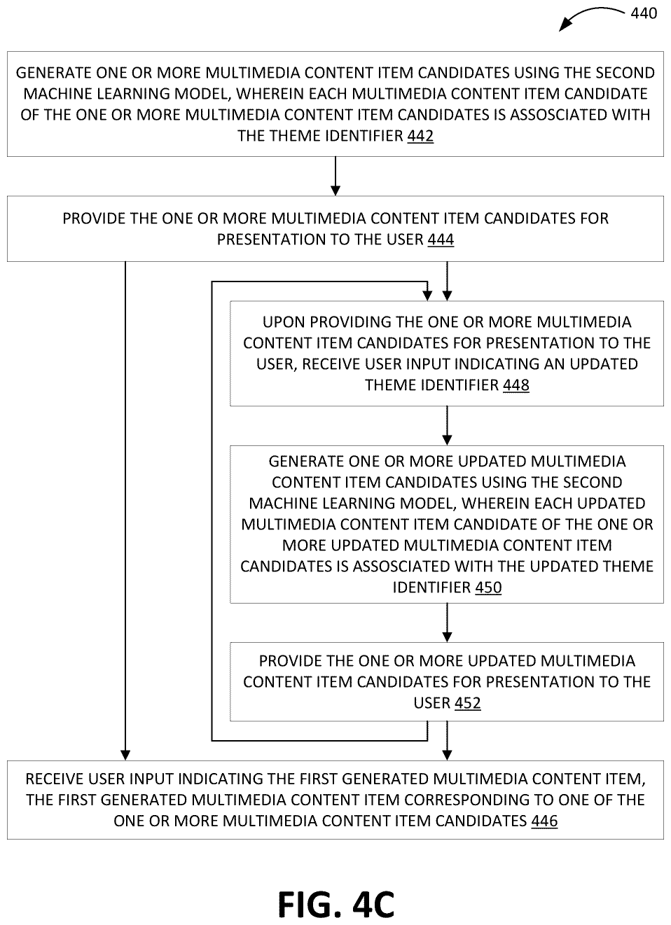

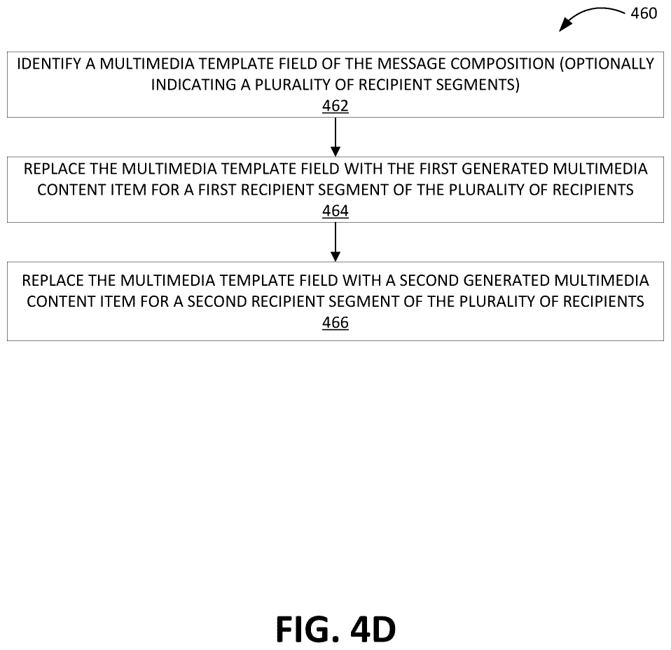

FIGS. 4A-D illustrate flow diagrams for example method 400 for theme-based multimedia attachment to message compositions using artificial intelligence and for example methods 420, 440, and 460, in accordance with at least one embodiment. Each method's individual functions, routines, subroutines, or operations can be performed by a processing device (e.g., processor(s) 102) communicatively coupled to a memory device (e.g., memory 104). In at least one embodiment, methods 400, 420, 440, and 460 can be performed by a single processing thread or alternatively by two or more processing threads, each thread executing one or more individual functions, routines, subroutines, or operations of the method. Methods 400, 420, 440, and 460 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In at least one embodiment, one or more non-transitory computer-readable media may store instructions that, when executed by a processing device, cause the processing device to perform methods 400, 420, 440, and 460. In at least one embodiment, methods 400, 420, 440, and 460 are performed by messaging system 116 on electronic communication platform 100 described with respect to FIG. 1. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in at least one embodiment. Thus, not all illustrated operations are required in every embodiment, and other process flows are possible. In at least one embodiment, the same, different, fewer, or greater operations can be performed.

Referring to FIG. 4A and example method 400, processing logic of a communication platform receives a message composition of a user at operation 402. As described herein, a message composition may be an email, a text message, a document, a presentation, an electronic mass communication message template (e.g., for a messaging campaign), etc., and the message composition may be received via a graphical user interface (e.g., GUI 118, composition view 202), an application programming interface (e.g., API 120), or other channel. A user (e.g., an entity or marketer) may have an account associated with the communication platform (e.g., as a service subscriber), which may be associated with one or more messaging campaigns. A messaging campaign (e.g., a marketing campaign) may involve automatically communicating a series of messages to recipients with various rules dictating which recipients receive which messages, the order in which to send the messages, communication protocols to be used to send the messages, the duration of time between sending messages, other triggers for sending messages, and similar. These rules may be established by the user for each messaging campaign or for all campaigns associated with their account, or the platform may use a set of default rules if those rules are not specified by the user. The user's account may include configuration data for each message campaign and associated rules, including the campaign messages or templates of the messages, recipients, recipient segments, communication channels (e.g., email, SMS), distribution order and timing, and similar. The received message composition at operation 402 may be obtained from the configuration data associated with the messaging campaign.

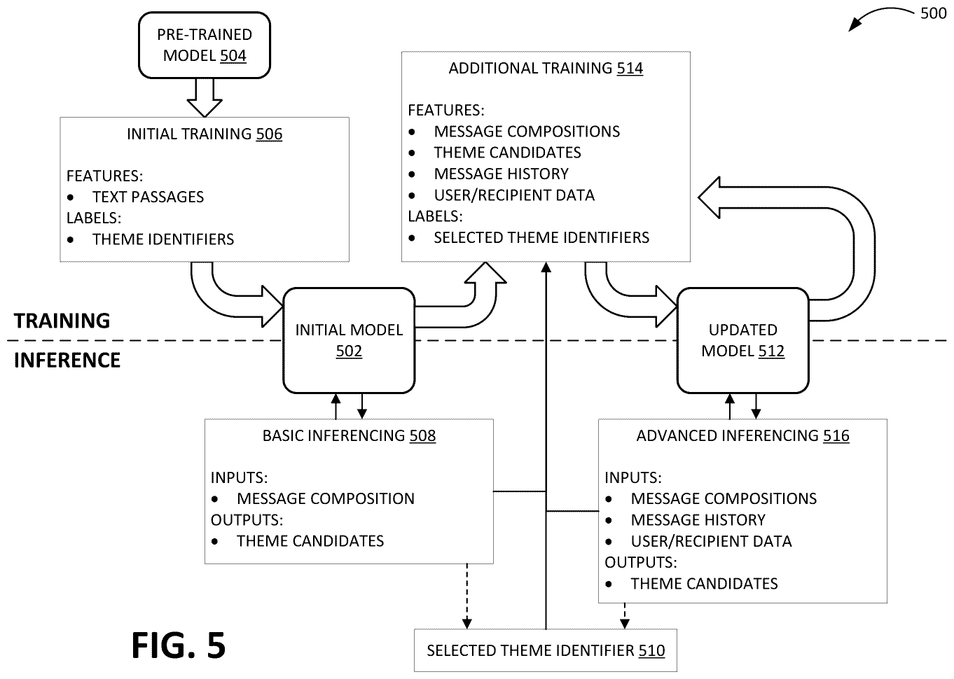

At operation 404, processing logic of a communication platform uses a first machine learning model to determine a theme identifier associated with a theme of the composition. The theme identifier may be a descriptive text caption, or another format as described herein. The first machine learning model may comprise a transformer ML model or another architecture as described herein and may be trained using the methods described herein with respect to FIG. 5. In at least one embodiment, operation 404 may comprise the operations of method 420 of FIG. 4B.

At operation 406, processing logic of a communication platform uses a second machine learning model to obtain a first generated multimedia content item corresponding to the theme identifier. The first generated multimedia content item may be an image or another type of multimedia as described herein. The second machine learning model may comprise a diffusion ML model or another architecture as described herein and maybe trained using the methods described herein with respect to FIG. 6. In at least one embodiment, operation 406 may comprise the operations of method 440 of FIG. 4C.

At operation 408, processing logic of a communication platform adds the first generated multimedia content item to the message composition to produce a customized message to be transmitted to a plurality of recipient devices each associated with one of a plurality of recipients. For example, the customized message may be customized with the multimedia content item and other customizations unique for each individual recipient or for each recipient segment based on the templating and segmentation techniques described with respect to FIGS. 3A-C. In at least one embodiment, the recipient devices may be devices 112A-n of FIG. 1 and transmission may occur via I/O peripherals 106 and/or network 114 of FIG. 1. In at least one embodiment, operation 408 may comprise the operations of method 460 of FIG. 4D. In at least one embodiment, processing logic distributes the resulting message composition to multiple recipients as part of an automated messaging campaign associated with the account of the user. Transmission for an automated messaging campaign may involve processing logic analyzing configuration data associated with the user's account or messaging campaign (or using system default rules) to determine which message to send, which recipients or recipient segments to send the message to, what time to send the message, and which communication channel (e.g., email, SMS) to use for sending the message.

Referring to FIG. 4B, example method 420 can be used to determine a theme identifier associated with a theme of a message composition, according to at least one embodiment. At operation 422, processing logic of a communication platform generates one or more theme candidates using the first machine learning model. Each theme candidate is associated with the theme(s) of the message composition. For example, referring to the example composition of FIG. 2, themes of the message composition may include “New Year's,” “Gratitude,” and “Business Relationship.” Each of these themes may be represented by a theme identifier and together comprise the theme candidates.

At operation 424, processing logic of a communication platform provides the theme candidates for presentation to the user. For example, the theme candidates may be provided via GUI 118 or API 120 of FIG. 1 and presented by theme selection view 204 of FIG. 2.

At operation 426, processing logic of a communication platform receives user input indicating the theme identifier. The indicated theme identifier corresponds to one of the theme candidates, which may encompass theme candidates modified by the user and user-generated theme candidates. In at least one embodiment, the user input may indicate multiple theme identifiers to use in the multimedia content generation operations.

Referring to FIG. 4C, example method 440 can be used to obtain a first generated multimedia content item, according to at least one embodiment. At operation 442, processing logic of a communication platform generates one or more multimedia content item candidates using the second machine learning model. Each multimedia content candidate is associated with the theme identifier. As described with respect to FIG. 3B-C, multimedia content candidates may also be associated with recipient segments.

At operation 444, processing logic of a communication platform provides the multimedia content item candidates for presentation to the user. For example, the multimedia content item candidates may be provided via GUI 118 or API 120 of FIG. 1 and presented by multimedia content item selection view 206 of FIG. 2.

In at least one embodiment, operation 444 may proceed to operation 446, where processing logic of a communication platform receives user input indicating the first generated multimedia content item. The first generated multimedia content item corresponds to one of the multimedia content item candidates, which may encompass multimedia content item candidates modified by the user (e.g., with image editing software) and user-generated multimedia content item candidates (e.g., images uploaded by the user). In at least one embodiment, the user input may indicate multiple multimedia content items to add to the message composition, such as the second generated multimedia content item described with respect to FIG. 4D.

In at least one embodiment, operation 444 may proceed to operation sequence 448-450-452 before proceeding to operation 444. Operation sequence 448-450-452 may occur once or may occur in a loop. At operation 448, upon providing the multimedia content item candidates for presentation to the user, the processing logic of a communication platform receives user input indicating an updated theme identifier. For example, the user may have determined that none of the multimedia content item candidates were sufficient and may have elected to revise the previously selected theme identifier (e.g., by activating a “Revise Theme” GUI element).

At operation 450, processing logic of a communication platform generates one or more updated multimedia content item candidates using the second machine learning model. Each updated multimedia content candidate is associated with the updated theme identifier. As described herein, updated multimedia content candidates may also be associated with previously selected theme identifiers and previous multimedia content candidates to provide continuity between generations of multimedia content candidates.

At operation 452, processing logic of a communication platform provides the updated multimedia content item candidates for presentation to the user as in operation 444. Processing logic may proceed to operation 446 or may loop back to operation 448.

Referring to FIG. 4D, example method 460 can be used to add the first generated multimedia content item to the message composition, according to at least one embodiment. At operation 462, processing logic of a communication platform identifies a multimedia template field of the message composition. In at least one embodiment, the multimedia template field further indicates two or more recipient segments, such as described with respect to FIG. 3B.

At operation 464, processing logic of a communication platform replaces the multimedia template field with the first generated multimedia content item for a first recipient segment of the plurality of recipients. If the template field does not indicate any recipient segments, the first recipient segment may correspond to all recipients. Processing logic may stop method 460 here in this case. If the template field indicates two or more recipient segments, the first recipient segment may correspond to one of those segments. Processing logic may continue to operation 466 in this case.

At operation 466, processing logic of a communication platform replaces the multimedia template field with a second generated multimedia content item for a second recipient segment of the plurality of recipients. In at least one embodiment, additional operations may be repeated to add additional multimedia content items for additional recipient segments.

FIG. 5 illustrates an example machine learning training and inference pipeline 500 (which may correspond to ML training pipeline 134 of FIG. 1) for a theme determination tool of a messaging system of a transactional and communication messaging platform, in accordance with at least one embodiment. ML training and inference pipeline 500 includes initial machine learning model 502. ML model 502 may comprise one or more of the network architectures described herein, a combination of architectures working in concert, or other ML designs and architectures as appropriate. In at least one embodiment, ML model 502 may be trained from pre-trained model 504 at initial training stage 506 using transfer learning techniques. At initial training stage 506, curated training data is used to re-train or continue training the pre-trained network with machine learning techniques such as backpropagation and gradient descent. Curated training data may include features such as text passages and labels such as theme identifiers summarizing the corresponding text passages. Other features and labels and other training techniques may be used as well. Pre-trained model 504 may be a pre-trained transformer network such at GPT-3® or a pre-trained convolutional neural network such as ResNet, for example. In at least one embodiment, additional layers or networks may be added to the pre-trained model to match the input and output shapes associated with the messaging system. During training, the original pre-trained model may be used as a fixed feature extractor while the additional layers or networks are trained, or the pre-trained model may be fine-tuned along with the additional layers. In at least one embodiment, a randomly initialized model may be used instead of a pre-trained model. Random initialization techniques that may be used include Xavier initialization and He initialization, for example.

In at least one embodiment, initial model 502 may be deployed to perform theme determination for the messaging system, as described herein. Initial model 502 may be deployed as ML model 130 of FIG. 1, for example. As part of the theme determination process, initial model 502 may perform inferencing such as basic inferencing stage 508, for example. At basic inferencing stage 508, user message compositions may be provided as input to initial model 502, and one or more theme candidates may be obtained as output from model 502. Other inputs and outputs may be used as well. For example, initial model 502 may also output confidence weights associated with each theme candidate output. In at least one embodiment, the user may select a theme identifier (e.g., selected theme identifier 510) from one of the theme candidates from basic inferencing stage 508 as an additional part of the theme determination process, as described herein.

In at least one embodiment, initial model 502 may be refined and updated to become updated model 512 using an additional training stage such as additional training stage 514. Additional training stage 514 may use new training data with the same features and labels as initial training stage 506, or it may use new training data with different features and labels. For example, the text passages of initial training stage 506 may be replaced with actual user message compositions (basic inferencing stage 508 inputs) and the theme identifiers of initial training stage 506 may be replaced with user-selected theme identifiers 510 (new training data, same features and labels). As an additional example, previously presented theme candidates that were not chosen by the user may be added as additional features. This may be advantageous for teaching the model to better reflect user preferences. Other user data such as messaging history or user/recipient data may be used for training as well. In at least one embodiment, updated model 512 may use the same model architecture as initial model 502, or it may use a different model architecture (such as to accommodate new features and labels). In at least one embodiment, updated model 512 may be continuously or periodically updated using additional training stage 514 to reflect newly available training data. In at least one embodiment, a single updated model 512 is trained and deployed for all users (using all users' data for training). In at least one embodiment, multiple updated models 512 are trained and deployed for individual users or groups of users and may be trained with user-specific data to provide a more customized experience.

Updated model 512 may be deployed as previously described to perform inferencing such as basic inferencing stage 508. In at least one embodiment, updated model 512 may perform advanced inferencing, such as advanced inferencing stage 516. At advanced inferencing stage 516, additional inputs such as messaging history and user/recipient data are provided to the model to produce more relevant theme candidates. As previously described, the user may select selected theme identifier 510 from the theme candidate outputs. The advanced inferencing stage 516 inputs and outputs and user selections may be fed back into additional training stage 514 as additional training data.

FIG. 6 illustrates an example machine learning training and inference pipeline 600 (which may correspond to ML training pipeline 134 of FIG. 1) for a multimedia content item generation tool of a messaging system of a transactional and communication messaging platform, in accordance with at least one embodiment. ML training and inference pipeline 600 includes initial machine learning model 602. ML model 602 may comprise one or more of the network architectures described herein, a combination of architectures working in concert, or other ML designs and architectures as appropriate. In at least one embodiment, ML model 602 may be trained from pre-trained model 604 at initial training stage 606 using transfer learning techniques. At initial training stage 606, curated training data is used to re-train or continue training the pre-trained network with machine learning techniques such as backpropagation and gradient descent. Curated training data may include features such as text prompts and labels such as multimedia content items (e.g., images) depicting the content of the text prompts. Other features and labels and other training techniques may be used as well. Pre-trained model 604 may be a pre-trained diffusion network such at DALL-E® or Stable Diffusion®, for example. In at least one embodiment, additional layers or networks may be added to the pre-trained model to match the input and output shapes associated with the messaging system. During training, the original pre-trained model may be used as a fixed feature extractor while the additional layers or networks are trained, or the pre-trained model may be fine-tuned along with the additional layers. In at least one embodiment, a randomly initialized model may be used instead of a pre-trained model. Random initialization techniques that may be used include Xavier initialization and He initialization, for example.

In at least one embodiment, initial model 602 may be deployed to perform multimedia content item generation for the messaging system, as described herein. Initial model 602 may be deployed as ML model 132 of FIG. 1, for example. As part of the multimedia content generation process, initial model 602 may perform inferencing such as basic inferencing stage 608, for example. At basic inferencing stage 608, user-selected theme identifiers may be provided as input to initial model 602, and one or more multimedia content item candidates may be obtained as output from model 602. Other inputs and outputs may be used as well. For example, initial model 602 may also output confidence weights associated with each multimedia content item candidate output. In at least one embodiment, the user may select a multimedia content item (e.g., selected content item 610) from one of the multimedia content item candidates from basic inferencing stage 608 as an additional part of the multimedia content item generation process, as described herein.

In at least one embodiment, initial model 602 may be refined and updated to become updated model 612 using an additional training stage such as additional training stage 614. Additional training stage 614 may use new training data with the same features and labels as initial training stage 606, or it may use new training data with different features and labels. For example, the text prompts of initial training stage 606 may be replaced with actual user-selected theme identifiers (basic inferencing stage 608 inputs) and the multimedia content items of initial training stage 606 may be replaced with user-selected content items 610 (new training data, same features and labels). As an additional example, previously presented multimedia content item candidates that were not chosen by the user may be added as additional features. This may be advantageous for teaching the model to better reflect user preferences. Other user data such as recipient segments or previous theme identifiers and content item candidates (where the user chose to revise the theme identifier one or more times) may be used for training as well. In at least one embodiment, updated model 612 may use the same model architecture as initial model 602, or it may use a different model architecture (such as to accommodate new features and labels). In at least one embodiment, updated model 612 may be continuously or periodically updated using additional training stage 614 to reflect newly available training data. In at least one embodiment, a single updated model 612 is trained and deployed for all users (using all users' data for training). In at least one embodiment, multiple updated models 612 are trained and deployed for individual users or groups of users and may be trained with user-specific data to provide a more customized experience.

Updated model 612 may be deployed as previously described to perform inferencing such as basic inferencing stage 608. In at least one embodiment, updated model 612 may perform advanced inferencing, such as advanced inferencing stage 616. At advanced inferencing stage 616, additional inputs such as recipient segments and previous theme identifiers and content item candidates are provided to the model to produce more relevant multimedia content item candidates. As previously described, the user may select selected content item 610 from the multimedia content item candidate outputs. The advanced inferencing stage 616 inputs and outputs and user selections may be fed back into additional training stage 614 as additional training data.

FIG. 7 is a block diagram illustrating an exemplary computer system 700, in accordance with an embodiment of the disclosure. The computer system 700 executes one or more sets of instructions that cause the machine to perform any one or more of the methodologies discussed herein. Set of instructions, instructions, and the like may refer to instructions that, when executed by computer system 700, cause computer system 700 to perform one or more operations of messaging system 116 of FIG. 1. The machine may operate in the capacity of a server or a client device in a client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 700 includes a processing device 702, a main memory 704 (e.g., read-only memory (ROM), flash memory, dynamic random-access memory (DRAM) such as synchronous DRAM (SDRAM) or Rambus DRAM (RDRAM), etc.), a static memory 706 (e.g., flash memory, static random-access memory (SRAM), etc.), and a data storage device 716, which communicate with each other via a bus 708.

The processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 702 may also be one or more special-purpose processing devices such as an application specific integrated circuit (ASIC), a field programmable gate array (FPGA), a digital signal processor (DSP), network processor, or the like. The processing device 702 is configured to execute instructions of the electronic communication platform 100 and messaging system 116 for performing the operations discussed herein.

The computer system 700 may further include a network interface device 722 that provides communication with other machines over a network 718, such as a local area network (LAN), an intranet, an extranet, or the Internet. The computer system 700 also may include a display device 710 (e.g., a liquid crystal display (LCD) or a cathode ray tube (CRT)), an alphanumeric input device 712 (e.g., a keyboard), a cursor control device 714 (e.g., a mouse), and a signal generation device 720 (e.g., a speaker).

The data storage device 716 may include a non-transitory computer-readable storage medium 724 on which is stored the sets of instructions of the electronic communication platform 100 or messaging system 116 embodying any one or more of the methodologies or functions described herein. The sets of instructions of the electronic communication platform 100 and of messaging system 116 may also reside, completely or at least partially, within the main memory 704 and/or within the processing device 702 during execution thereof by the computer system 700, the main memory 704 and the processing device 702 also constituting computer-readable storage media. The sets of instructions may further be transmitted or received over the network 718 via the network interface device 722.

While the example of the computer-readable storage medium 724 is shown as a single medium, the term “computer-readable storage medium” can include a single medium or multiple media (e.g., a centralized or distributed database, and/or associated caches and servers) that store the sets of instructions. The term “computer-readable storage medium” can include any medium that is capable of storing, encoding or carrying a set of instructions for execution by the machine and that causes the machine to perform any one or more of the methodologies of the disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating”, “providing”, “receiving”, “identifying”, “determining”, “sending”, “enabling” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above-described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled.

What is claimed is:

1. A method comprising:
receiving, by a communication platform, a message composition of a user;
determining, by the communication platform and using a first machine learning model, a theme identifier associated with a theme of the message composition;
obtaining, by the communication platform and using a second machine learning model, a first generated content item corresponding to the theme identifier; and
adding, by the communication platform, the first generated content item to the message composition to produce a customized message to be transmitted to a plurality of recipient devices each associated with one of a plurality of recipients.

2. The method of claim 1, wherein determining the theme identifier further comprises:
generating one or more theme candidates using the first machine learning model, wherein each theme candidate of the one or more theme candidates is associated with the theme of the message composition;
providing the one or more theme candidates for presentation to the user; and
receiving user input indicating the theme identifier, the theme identifier corresponding to one of the one or more theme candidates.

3. The method of claim 2, wherein generating the one or more theme candidates further comprises:
providing content of the message composition as input to the first machine learning model; and
obtaining an output of the first machine learning model, the output indicating the one or more theme candidates.

4. The method of claim 1, wherein the first generated content item is a first generated multimedia content item, and wherein obtaining the first generated multimedia content item further comprises:
generating one or more multimedia content item candidates using the second machine learning model, wherein each multimedia content item candidate of the one or more multimedia content item candidates is associated with the theme identifier;
providing the one or more multimedia content item candidates for presentation to the user; and
receiving user input indicating the first generated multimedia content item, the first generated multimedia content item corresponding to one of the one or more multimedia content item candidates.

5. The method of claim 4, wherein generating the one or more multimedia content item candidates further comprises:
providing the theme identifier as input to the second machine learning model; and
obtaining an output of the second machine learning model, the output indicating the one or more multimedia content item candidates.

6. The method of claim 4, further comprising:
upon providing the one or more multimedia content item candidates for presentation to the user, receiving user input indicating an updated theme identifier;
generating one or more updated multimedia content item candidates using the second machine learning model, wherein each updated multimedia content item candidate of the one or more updated multimedia content item candidates is associated with the updated theme identifier; and
providing the one or more updated multimedia content item candidates for presentation to the user.

7. The method of claim 1, wherein adding the first generated content item to the message composition further comprises:
identifying a template field of the message composition; and
replacing the template field with the first generated content item for a first recipient segment of the plurality of recipients.

8. The method of claim 7, wherein the template field further indicates a plurality of recipient segments of the plurality of recipients, the method further comprising replacing the template field with a second generated content item for a second recipient segment of the plurality of recipients.

9. The method of claim 1, wherein the message composition is an electronic mass communication message template, the theme identifier is a descriptive text caption, and the first generated content item is an image.

10. The method of claim 1, wherein the first machine learning model is a transformer machine learning model, and the second machine learning model is a diffusion machine learning model.

11. A system comprising:
a memory; and
a processing device, coupled to the memory, to perform operations comprising:
receiving, by a communication platform, a message composition of a user;
determining, by the communication platform and using a first machine learning model, a theme identifier associated with a theme of the message composition;
obtaining, by the communication platform and using a second machine learning model, a first generated content item corresponding to the theme identifier; and
adding, by the communication platform, the first generated content item to the message composition to produce a customized message to be transmitted to a plurality of recipient devices each associated with one of a plurality of recipients.

12. The system of claim 11, wherein determining the theme identifier further comprises:
generating one or more theme candidates using the first machine learning model, wherein each theme candidate of the one or more theme candidates is associated with the theme of the message composition;
providing the one or more theme candidates for presentation to the user; and
receiving user input indicating the theme identifier, the theme identifier corresponding to one of the one or more theme candidates.

13. The system of claim 12, wherein generating the one or more theme candidates further comprises:
providing content of the message composition as input to the first machine learning model; and
obtaining an output of the first machine learning model, the output indicating the one or more theme candidates.

14. The system of claim 11, wherein adding the first generated content item to the message composition further comprises:
identifying a template field of the message composition; and
replacing the template field with the first generated content item for a first recipient segment of the plurality of recipients.

15. The system of claim 14, wherein the template field further indicates a plurality of recipient segments of the plurality of recipients, the operations further comprising replacing the template field with a second generated content item for a second recipient segment of the plurality of recipients.

16. A non-transitory computer-readable medium comprising instructions that, responsive to execution by a processing device, cause the processing device to perform operations comprising:
receiving, by a communication platform, a message composition of a user;
determining, by the communication platform and using a first machine learning model, a theme identifier associated with a theme of the message composition;
obtaining, by the communication platform and using a second machine learning model, a first generated content item corresponding to the theme identifier; and
adding, by the communication platform, the first generated content item to the message composition to produce a customized message to be transmitted to a plurality of recipient devices each associated with one of a plurality of recipients.

17. The non-transitory computer-readable medium of claim 16, wherein the first generated content item is a first generated multimedia content item, and wherein obtaining the first generated multimedia content item further comprises:
generating one or more multimedia content item candidates using the second machine learning model, wherein each multimedia content item candidate of the one or more multimedia content item candidates is associated with the theme identifier;
providing the one or more multimedia content item candidates for presentation to the user; and
receiving user input indicating the first generated multimedia content item, the first generated multimedia content item corresponding to one of the one or more multimedia content item candidates.

18. The non-transitory computer-readable medium of claim 17, wherein generating the one or more multimedia content item candidates further comprises:
providing the theme identifier as input to the second machine learning model; and
obtaining an output of the second machine learning model, the output indicating the one or more multimedia content item candidates.

19. The non-transitory computer-readable medium of claim 17, the operations further comprising:
upon providing the one or more multimedia content item candidates for presentation to the user, receiving user input indicating an updated theme identifier;
generating one or more updated multimedia content item candidates using the second machine learning model, wherein each updated multimedia content item candidate of the one or more updated multimedia content item candidates is associated with the updated theme identifier; and
providing the one or more updated multimedia content item candidates for presentation to the user.

20. The non-transitory computer-readable medium of claim 16, wherein the message composition is an electronic mass communication message template, the theme identifier is a descriptive text caption, and the first generated multimedia content item is an image.
